(19) United States
(12) Patent Application Publication
(10) Pub. No.: US 2020/0118196 A1
(43) Pub. Date: Apr. 16, 2020

(54) SYSTEM AND METHOD FOR AUTOMATIC ORDERING OF CONTENTS OF BINS DRAWER TRAYS AND CABINETS

(71) Applicant: Robert Carryl, Jacksonville, FL (US)

(72) Inventor: Robert Carryl, Jacksonville, FL (US)

(21) Appl. No.: 16/564,026

(22) Filed: Sep. 9, 2019

Related U.S. Application Data
(60) Provisional application No. 62/745,276, filed on Oct. 12, 2018.

(51) Int. Cl. G06Q 30/06; G06Q 10/08

(52) U.S. Cl. CPC G06Q 30/0635; G06Q 10/087

(57) ABSTRACT

The present invention is a system and method for the automatic ordering of contents of bins, drawer trays and cabinets. The present invention automatically orders fastener bolt bins and industrial supply bins, drawer trays, and cabinets. The present invention works by integrating a scale or other weight sensing device or material into each compartment that holds parts.

This application claims priority to U.S. provisional application 62/745,276 filed on 12 Oct. 2018, the entire disclosure of which is incorporated by reference herein.

### BACKGROUND OF THE INVENTION

### Field of the Invention

The present invention is in the field of industrial supply. More specifically, the present invention is a system and method for the automatic ordering of contents of bins, drawer trays and cabinets.

### Background of the Invention

The present invention is a system and method for the automatic ordering of contents of bins, drawer trays and cabinets. In the past, checking stock levels in fastener bolt bins and industrial supply tray drawers and cabinets has been very labor intensive. Prior to this invention it required a person to visually check the stock level in each compartment. Usually this person was an industrial supply company's route sales person, or an employee of the company that uses the supplies in the bins, tray drawer trays and cabinets. In either case these storage devices are checked daily, weekly, bi-weekly, monthly, on demand or as needed. The present invention automatically orders fastener bolt bins and industrial supply bins, drawer trays, and cabinets. The present invention works by integrating a scale or other weight sensing device or material into each compartment that holds parts. Connecting each weight sensing device to an attached electronic control board. Connecting the control board to the Internet using a CAT 5 cable or other appropriate method.

Connecting a software program to the Internet and pulling that weight data into the software program. Since the unit weight of each item in each compartment is known and is stored in the software program, the software calculates the number of pieces on hand from the transmitted weight for each compartment, since the software also stores the unit cost the user can see the exact inventory dollar amount on hand. The software also stores the reorder point for each item and the maximum quantity to stock. Based on the weight in each compartment which is converted to the number of pieces on hand in each compartment, the software identifies the items that are below the reorder point and can automatically generate an order that can be transmitted in various forms to the supplier the order can be in various forms such as via XML, EDI electronic data exchange, Fax or Phone.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a bin, in accordance with one embodiment of the present invention.

FIG. 2 illustrates a bin, in accordance with one embodiment of the present invention.

FIG. 3 illustrates a system, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

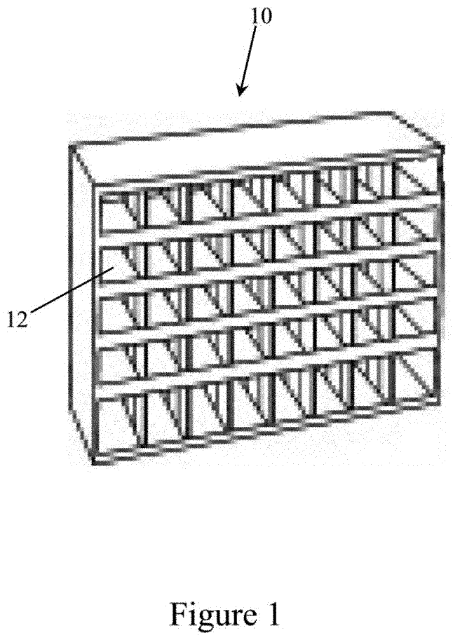

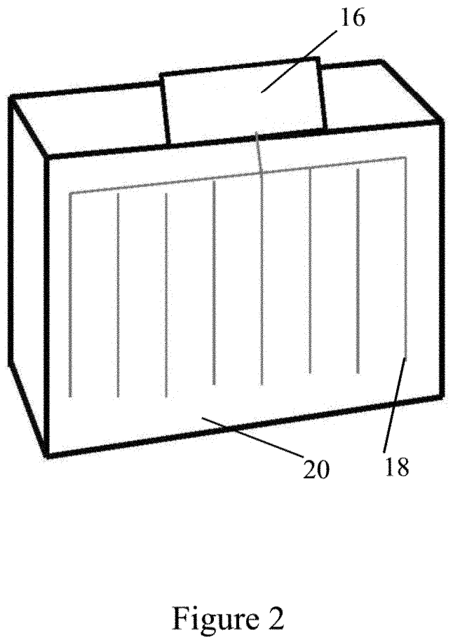

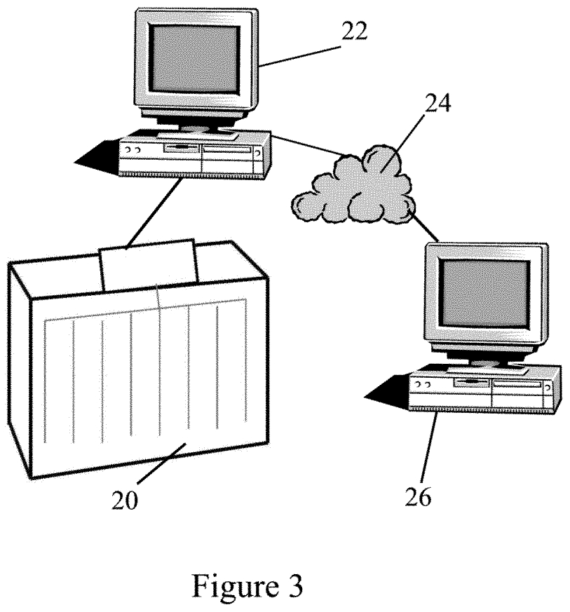

Referring now to FIG. 1, illustrated bin 10, in accordance with one embodiment of the present invention. In FIG. 1, illustrated is a scale 12 or weight sensing device or material that can weight items. There are a large number of various storage cabinets in existence for industrial parts, these include but are not limited to 40 hole bins, 72 hole bins, 12 hole bins, 24 hold bins, 36 hole bins, 56 hole bins, adjustable drawer trays, 24 hole drawer trays, 32 hole drawer trays, 12 hole drawer trays, as well cabinet and storage racking and shelves. In FIG. 2, illustrated is a bin back side 20 with a circuit 18 to connect the scales 12 or weight sensing devices to an electronic control board 16. In FIG. 3, illustrated is a user's computer 22 connected to the bin 10 and the user's computer is connected over the internet 24 to a supplier's computer 26.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. A method to automatically supply a bin comprising:
pulling weight data from an individual shelf the individual shelf has a self contents the self content is made up of unit weights of each component item with an item weight
calculating a number of pieces of each component item on hand to a user by taking the weight data and the stored known unit weight;
displaying an exact inventory dollar amount on hand by taking the stored unit cost and the number of pieces on hand; and
generating a order to a supplier when a predetermined stored reorder point and maximum stock quantity are meet.

2. The method to automatically supply a bin according to claim 1, wherein the order is automatically sent by fax.

3. The method to automatically supply a bin according to claim 1, wherein the order is automatically sent by phone.

4. The method to automatically supply a bin according to claim 1, wherein the order is automatically sent by EDI.

5. A method to automatically supply a compartment comprising:
pulling weight data from an individual shelf the individual shelf has a self contents the self content is made up of unit weights of each component item with an item weight
calculating a number of pieces of each component item on hand to a user by taking the weight data and the stored known unit weight;
displaying an exact inventory dollar amount on hand by taking the stored unit cost and the number of pieces on hand; and
generating a order to a supplier when a predetermined stored reorder point and maximum stock quantity are meet.

6. The method to automatically supply a compartment according to claim 5, wherein the order is automatically sent by fax.

7. The method to automatically supply a compartment according to claim 5, wherein the order is automatically sent by phone.

8. The method to automatically supply a compartment according to claim 5, wherein the order is automatically sent by EDI.

9. The method to automatically supply a compartment according to claim 5, wherein the compartment is a selected one of a bin, drawer tray or cabinet.
